(19) United States
(12) Patent Application Publication
(10) Pub. No.: US 2013/0265644 A1
(43) Pub. Date: Oct. 10, 2013

(54) SHIELDING APPARATUS AND SYSTEM FOR ELECTRONC DEVICE

(71) Applicant: Steven Armstrong, Topanga, CA (US)

(72) Inventor: Steven Armstrong, Topanga, CA (US)

(21) Appl. No.: 13/870,836

(22) Filed: Apr. 25, 2013

Related U.S. Application Data
(63) Continuation of application No. 13/856,240, filed on Apr. 3, 2013.
(60) Provisional application No. 61/620,110, filed on Apr. 4, 2012.
(60) Provisional application No. 61/669,914, filed on Jul. 10, 2012.

(51) Int. Cl. G02B 27/00

(52) U.S. Cl. CPC G02B 27/00
USPC 359/601

(57) ABSTRACT

An apparatus for shielding a display panel of an electronic device is described herein. The apparatus comprises a shade portion, holding portions and an attachment layer. The shade portion may surround a display panel of an electronic device and may limit a field of view to the display panel. The shade portion includes a backside shade portion and two side shade portions. The holding portions may include a bottom holding portion coupled to a bottom side of the backside shade portion and side holding portions coupled to each of the side shade portions. The attachment layer may be coupled to each of the side holding portions. The attachment layer may be a suction cup tape which may be removably coupled to the electronic device. Other embodiments are also described.

### CROSS-REFERENCED APPLICATIONS

This application is a continuation application of Ser. No. 13/856,240, filed on Apr. 3, 2013, that claims the benefit pursuant to 35 U.S.C. 119(e) of U.S. Provisional Application No. 61/620,110, filed Apr. 4, 2012, and of U.S. Provisional Application No. 61/669,914, filed Jul. 1, 2012, which applications are specifically incorporated herein, in their entirety, by reference.

### FIELD

An embodiment of the invention relate generally to an apparatus and system for shielding the display screen of an electronic device to provide privacy for the user, shade from light and blocking from heat.

### BACKGROUND

Currently, a wide range of portable consumer electronics allow users to access personal information, email, and navigate websites outside of the privacy of their homes. These portable consumer electronics may include, for example, smart phones, laptops, notebooks, tablet computers, and personal digital media players.

However, while the portability of the electronic devices is convenient for users, the use of the electronic devices in different locations may suffer from disadvantages. For instance, when the consumer electronic devices are used outside of the user's private home, the display screen of the electronic device may be visible to the public such that the user may be uncomfortable accessing his private information. Further, when the consumer electronic devices are used outside, the sunlight creates glare on the display screen or overheat the electronic device. Moreover, when using the electronic devices indoors in a dark environment, the user may also need to contain the light emitted from the device so as to not bother other people.

### SUMMARY

In one embodiment of the invention, to provide privacy, shade as well as protection from the sunlight, a shielding accessory may be used in conjunction with the electronic devices, which may be portable or stationary.

In one embodiment of the invention, an apparatus for shielding a display panel of an electronic device comprises a shade portion, holding portions and magnet portions. The shade portion may surround a display panel of an electronic device and may limit a field of view to the display panel. The shade portion includes a backside shade portion and two side shade portions. The holding portions may include a bottom holding portion coupled to a bottom side of the backside shade portion and side holding portions coupled to each of the side shade portions. The magnet portions may be included in the plurality of holding portions, respectively, and may couple to a housing that is coupled to the display panel.

In another embodiment of the invention, a system for shielding a display panel of an electronic device comprises a housing including a plurality of magnet portions, and a shielding apparatus. The housing may be a protective case for the electronic device. The shielding apparatus may comprise a shade portion, and holding portions. The shade portion may surround a display panel of an electronic device and may limit a field of view to the display panel. The shade portion includes a backside shade portion and two side shade portions. The holding portions include a bottom holding portion coupled to a bottom side of the backside shade portion and side holding portions coupled to each of the side shade portions. The holding portions respectively include portions of ferrous material that couple to the plurality of magnet portions in the housing, respectively.

The above summary does not include an exhaustive list of all aspects of the present invention. It is contemplated that the invention includes all systems, apparatuses and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 illustrates a front view of the shielding apparatus in accordance with a first embodiment of the invention coupled with a tablet device in a landscape orientation.

FIG. 2 illustrates a top view of the shielding apparatus in accordance with the first embodiment of the invention coupled with a tablet device in a landscape orientation.

FIG. 3 illustrates a perspective view of the shielding apparatus in accordance with the first embodiment of the invention coupled with a tablet device in a landscape orientation.

FIG. 4 illustrates a top view of the shielding apparatus in accordance with the first embodiment of the invention coupled with a tablet device in a landscape orientation.

FIG. 5 illustrates a bottom view of the shielding apparatus in accordance with the first embodiment of the invention.

FIGS. 6A-6C illustrate a front view of the shielding apparatus in accordance with the first embodiment of the invention in a folded position (FIG. 6A), a front view of the shielding apparatus in accordance with the first embodiment of the invention in a partially folded position (FIG. 6B), and a front view of the shielding apparatus in accordance with the first embodiment of the invention in an open position (FIG. 6C)

FIGS. 7A-7C illustrate a front view (FIG. 7A), a back view (FIG. 7B), and a side view (FIG. 7C) of a magnet portion of the shielding apparatus in accordance with the first embodiment of the invention.

FIGS. 8A-8D illustrate support structures of the shielding apparatus in accordance with various embodiments of the invention.

FIG. 9 illustrates a perspective view of the shielding apparatus in accordance with a second embodiment of the invention coupled with a tablet device in a landscape orientation.

FIG. 10 illustrates a front view of the shielding apparatus in accordance with a third embodiment of the invention.

FIG. 11 illustrates a top view of the shielding apparatus in accordance with a third embodiment of the invention.

FIG. 12 illustrates a perspective view of the shielding apparatus in accordance with a third embodiment of the invention.

FIG. 13 illustrates a front view of the shielding apparatus in accordance with the third embodiment of the invention.

FIG. 14 illustrates a top view of the shielding apparatus in accordance with a third embodiment of the invention coupled with a tablet device in a portrait orientation.

FIGS. 15A-15C illustrate a top view of the shielding apparatus in accordance with a fourth embodiment of the invention.

FIGS. 16A-16D illustrate front views of the shielding apparatus in accordance with a fifth embodiment of the invention (FIG. 16A-B), and top views of the shielding apparatus in accordance with the fifth embodiment of the invention (FIG. 16C-D).

FIG. 17 illustrates a perspective view of the shielding apparatus in accordance with a sixth embodiment of the invention.

FIGS. 18A-C illustrate a top view of the shielding apparatus according to an seventh embodiment of the invention coupled to a mobile telephone device (FIG. 18A), top view of the shielding apparatus according to an eighth embodiment of the invention coupled to a mobile telephone device (FIG. 18B), and front view of the shielding apparatus according to the eighth embodiment of the invention coupled to a mobile telephone device (FIG. 18C)

FIGS. 19A-B illustrate a top view of the shielding apparatus according to the eighth embodiment of the invention (FIG. 19A) and a side view according to the eight embodiment of the invention coupled to a mobile telephone device (FIG. 19B)

FIGS. 20A-20C illustrate a perspective view of the shielding apparatus according to a ninth embodiment of the invention in a light shielding mode (FIG. 20A), a perspective view of the shielding apparatus according to the ninth embodiment of the invention being converted from the light shielding mode to the privacy viewing mode (FIG. 20B) and a perspective view of the shielding apparatus according to the ninth embodiment of the invention in a privacy viewing mode (FIG. 20C).

FIG. 21 illustrates a top view of the shielding apparatus according to a tenth embodiment of the invention.

FIGS. 22A-22D illustrate an open shielding apparatus according to the ninth embodiment of the invention (FIG. 22A) and views of a folded shielding apparatus according to the ninth embodiment of the invention (FIGS. 22B-D).

FIGS. 23A-23D illustrate a top view according to eleventh embodiment of the invention (FIG. 23A) and front view according to eleventh embodiment of the invention (FIG. 23B).

FIGS. 24A-24D illustrate a top view of a housing according to the twelfth embodiment of the invention (FIG. 24A), a top view of a shielding apparatus according the twelfth embodiment of the invention coupled the housing (FIG. 24B), a front view of the twelfth embodiment of the invention coupled to the housing (FIG. 24C), and bottom view of the twelfth embodiment of the invention coupled to the housing (FIG. 24D).

FIG. 25 illustrates an open shielding apparatus according to a thirteenth embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

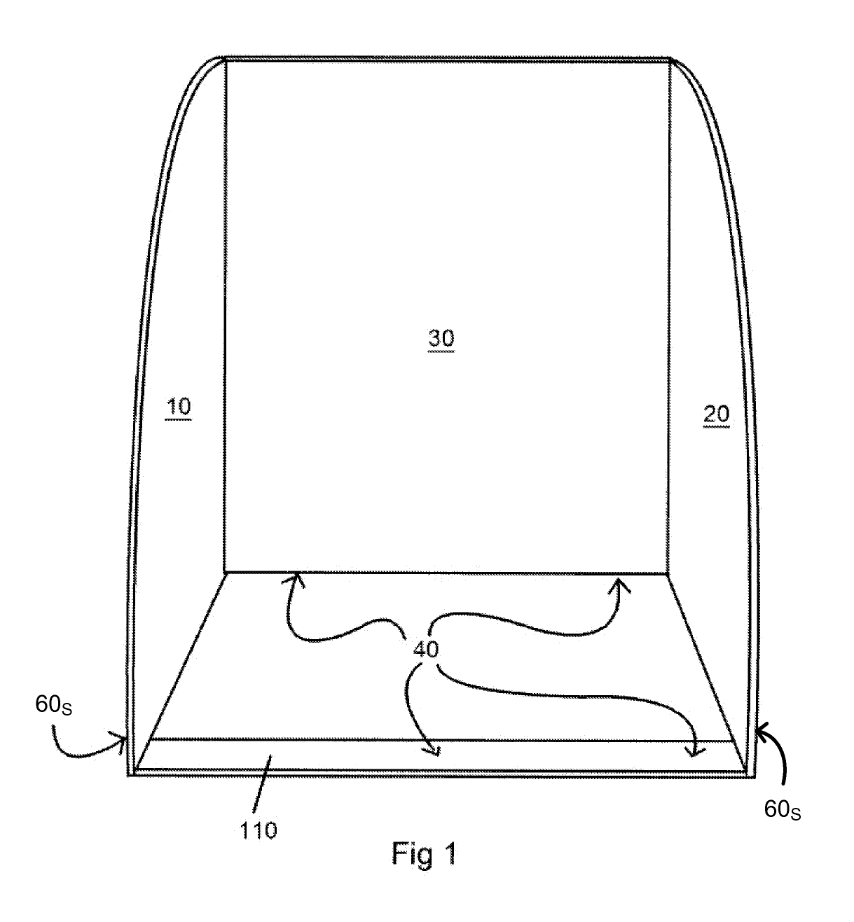

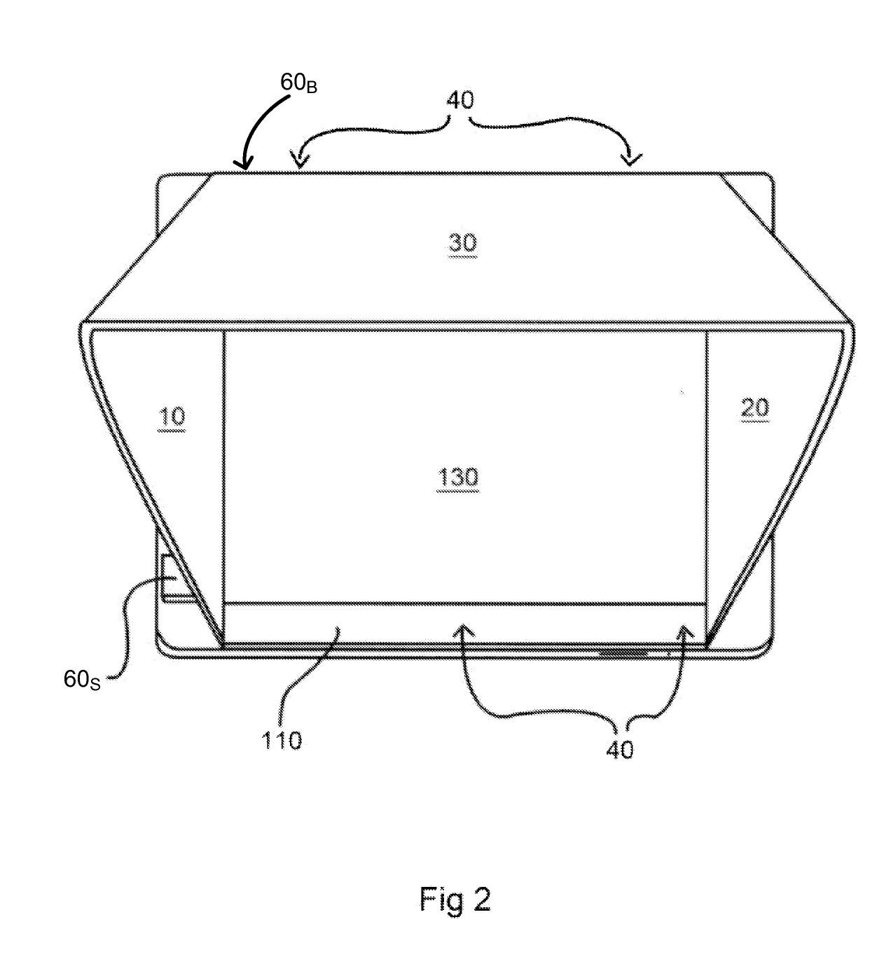

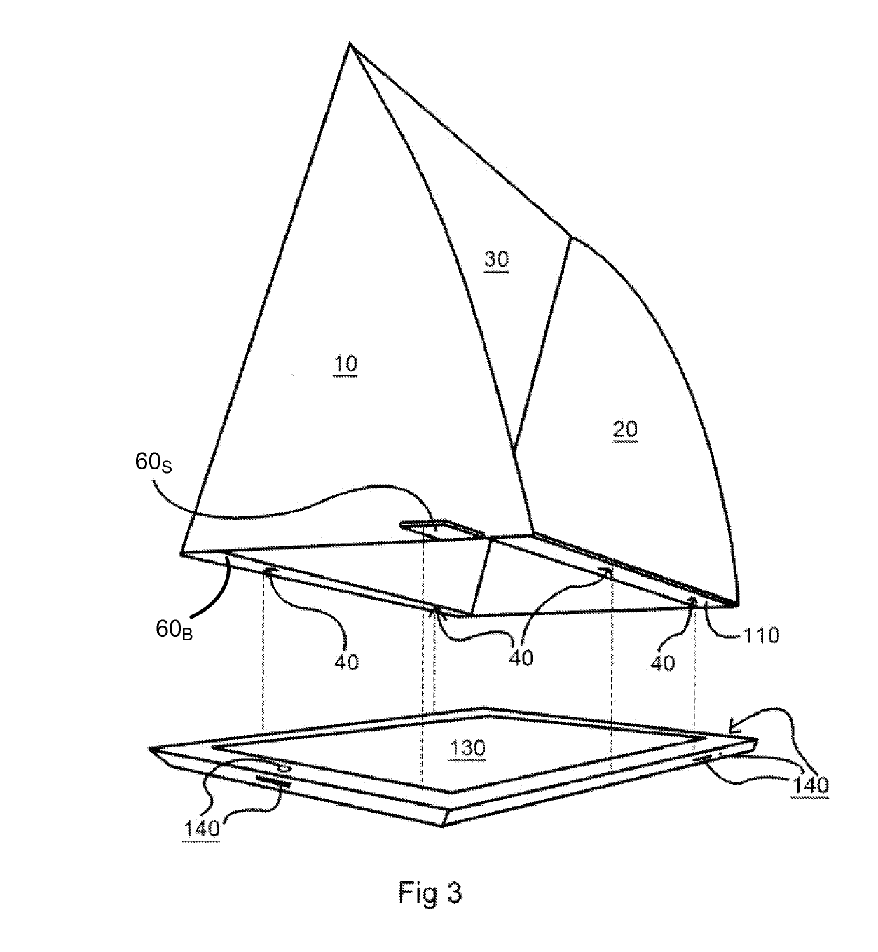

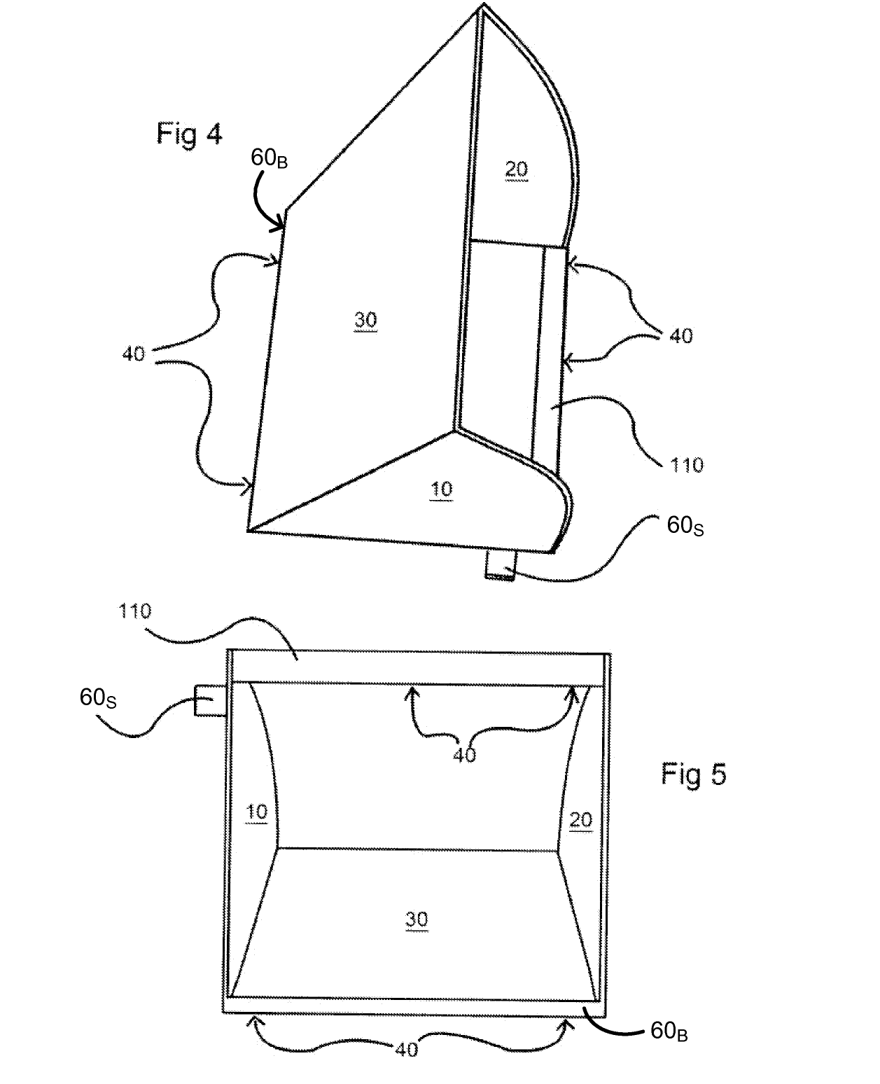

FIG. 1 illustrates a front view of the shielding apparatus in accordance with a first embodiment of the invention coupled with a tablet device in a landscape orientation. FIG. 2 illustrates a top view of the shielding apparatus in accordance with the first embodiment of the invention coupled with a tablet device in a landscape orientation. As shown in FIG. 2, the shielding apparatus may be used with a portable consumer electronic device (or “mobile device”). As shown in FIG. 1, the electronic device 130 may be a tablet computer. However, the electronic device 130 may also be a mobile telephone communications device or a smartphone. The electronic device 130 may also be a personal digital media player or a notebook computer. While FIG. 2 illustrates a electronic device 130, it is understood that embodiments of the invention may also be implemented in a non-mobile device such as a compact desktop computer. FIG. 3 illustrates a perspective view of the shielding apparatus in accordance with the first embodiment of the invention coupled with a tablet device in a landscape orientation. FIG. 4 illustrates a top view of the shielding apparatus in accordance with the first embodiment of the invention coupled with a tablet device in a landscape orientation. FIG. 5 illustrates a bottom view of the shielding apparatus in accordance with the first embodiment of the invention.

In this embodiment of the invention, the shielding apparatus includes a shade portion that includes a backside shade portion 30 and two side shade portions 10, 20, holding portions 60_{S}, 60_{B}, 110 and magnet portions 40. The shade portion may include a plurality of layers of fabric. The fabric may be, for instance, nylon or plastic. The fabric may also be resistant to Ultra-Violet rays such that it provides heat protection. A flexible material such as foam may be included between the layers of fabric. The flexible material may provide rigidity or structural support for the shielding apparatus such that the shape of the shade portion is maintained. For instance, as shown in FIGS. 1-5, when the shielding apparatus is open, the shade portion maintains its shape to surround the display panel of an electronic device 130 such as a tablet computer and thus, limiting a field of view to the display panel (privacy mode). Moreover, the height of the shade portion may also be configured to provide shade from the sun's glare or an external lighting source's glare on the display panel of the electronic device 130. As illustrated in FIGS. 1-5, the backside shade portion 30 may be at an angle from the display panel of the electronic device 130. In this embodiment, the materials included in the fabrication of the shielding apparatus are lightweight materials (e.g., fabric, magnets, foam, etc.).

In this embodiment, the holding portions may include a bottom holding portion 60_{B} coupled to a bottom side of the backside shade portion 30 and side holding portions 60_{S} coupled to each of the side shade portions 10, 20. In some embodiments, only one of the side shade portions 10 includes the side holding portion 60_{S}. In the embodiment shown in FIGS. 1-6, the holding portions also include the front band holding portion 110, which is coupled to the side shade portions 10, 20. The holding portions may be made of one or more layers of fabric that are sewn into the shape of a pouch. The holding portions may include flexible material such as foam therein. Each of the holding portions 60_{S}, 60_{B}, and 110 may include magnet portions 40, respectively, therein. As shown in FIG. 2-3, the magnet portions 40 may couple to the housing of an electronic device 130 such as a tablet computer. The magnet portions 40 may be magnetically coupled to ferrous material or opposing magnets included in the housing. The magnet portions 40 may include magnets that are coupled to spring steel.

Referring to FIG. 3, when the shielding apparatus is coupled to housing included in the electronic apparatus, the buttons, ports and jacks 140 of the electronic device are not covered by the shielding apparatus. Accordingly, the user may readily access these buttons, ports, and jacks 140 while the shielding apparatus coupled to the device.

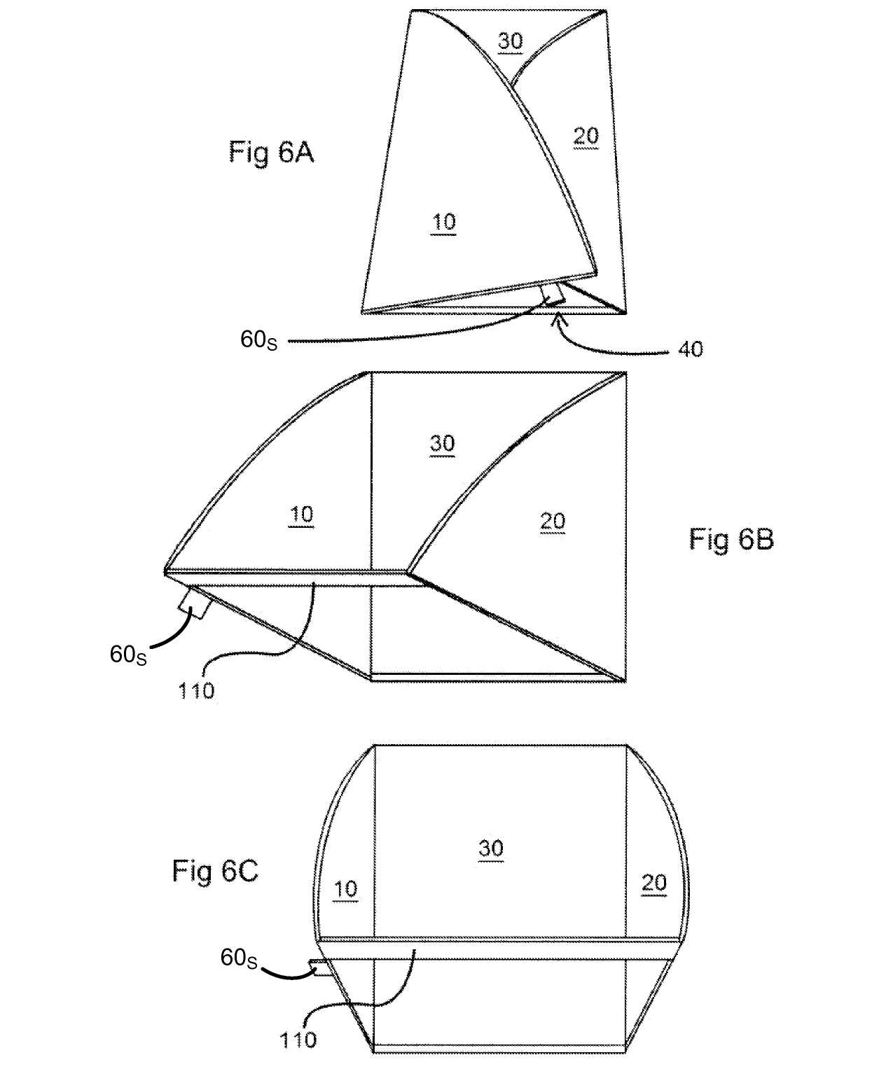

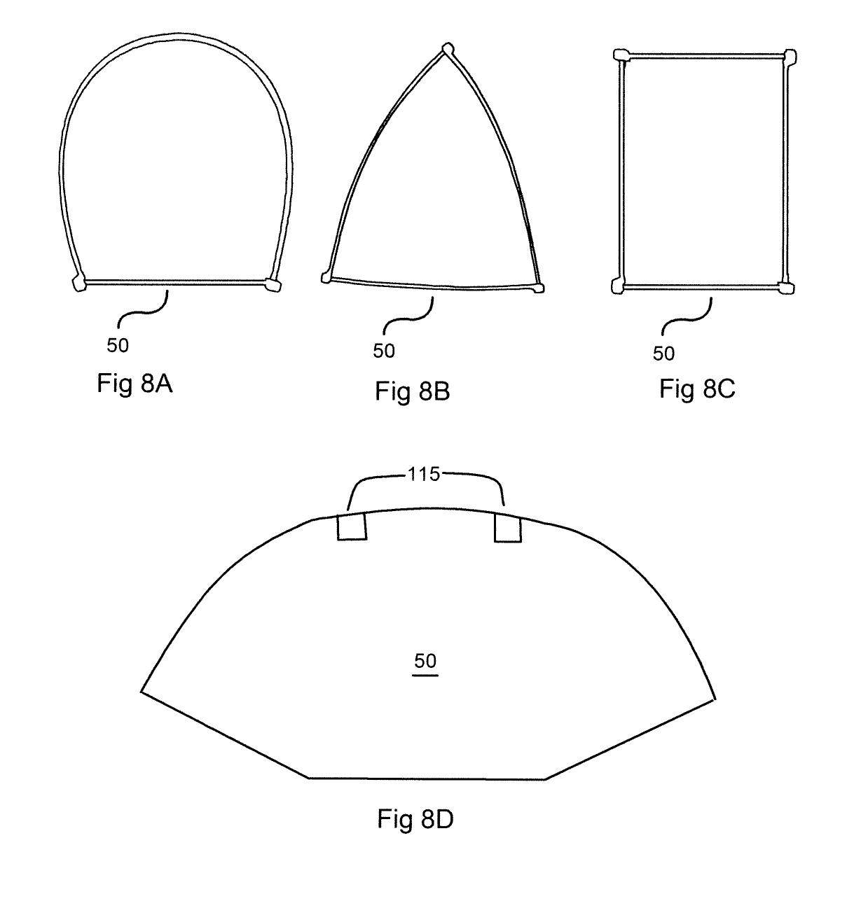

FIGS. 6A-6C illustrate a front view of the shielding apparatus in accordance with the first embodiment of the invention in a folded position (FIG. 6A), a front view of the shielding apparatus in accordance with the first embodiment of the invention in a partially folded position (FIG. 6B), and a front view of the shielding apparatus in accordance with the first embodiment of the invention in an open position (FIG. 6C). As shown in FIGS. 6A-6C, the shade portion of the shielding apparatus may be foldable at a seam located between the backside shade portion 30 and each of the two side shade portions 10, 20. In one embodiment, support structures 50 are included in between the plurality of layers of fabric of the shade portion to provide rigidity to the backside shade portion 30 and the two side shade portions 10, 20. FIGS. 8A-8D illustrate support structures 50 of the shielding apparatus in accordance with various embodiments of the invention. For instance, the support structures 50 may be include at the edges of the backside shade portion 30, the edges of the side shade portions 10, 20, as well as in the seams between the backside shade portion 30 and each of the side shade portions 10, 20. In some embodiments, the support structures are made of materials such as spring steel, plastic, elastic, and metal. For instance, FIGS. 8A-8C illustrate support structures 50 that are made plastic material and may be included in the edges of the side shade portions 10, 20. FIG. 8D illustrates an embodiment where the support structure 50 is made of spring steel and/or foam and is included in the edges of the shade portion (e.g., the perimeter of the shade portion). In the embodiment in FIG. 8D, the top side of the backside shade portion 30 is coupled to a holding portion 115 that includes a structure including portions of ferrous material.

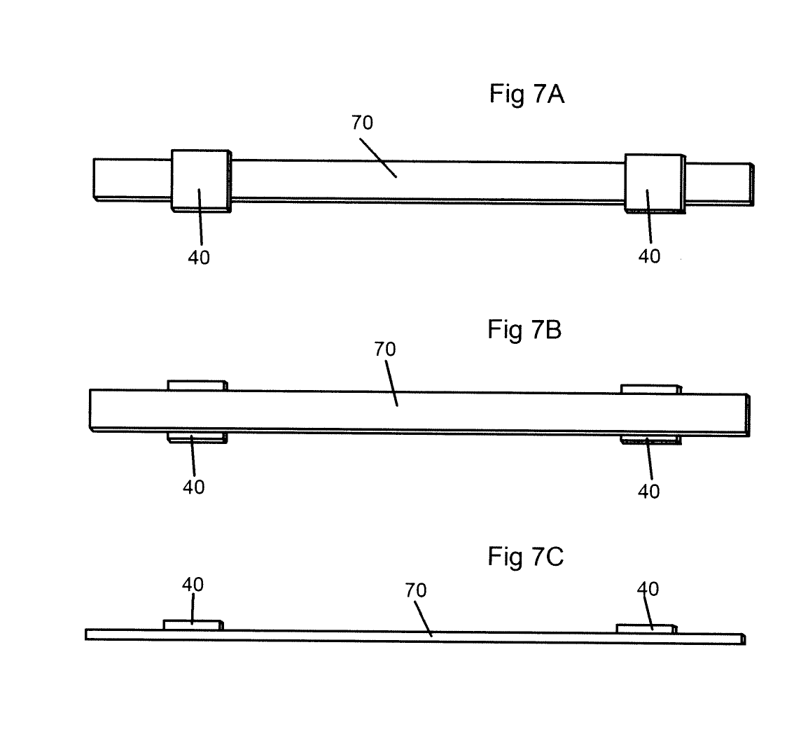

FIGS. 7A-7C illustrate a front view (FIG. 7A), a back view (FIG. 7B), and a side view (FIG. 7C) of a magnet portion of the shielding apparatus in accordance with the first embodiment of the invention. In this embodiment, the magnet portions include a structure 70 and a plurality of magnets 40 coupled to the structure 70. The structure 70 may be made of a material such as spring steel, metal, plastic, or foam.

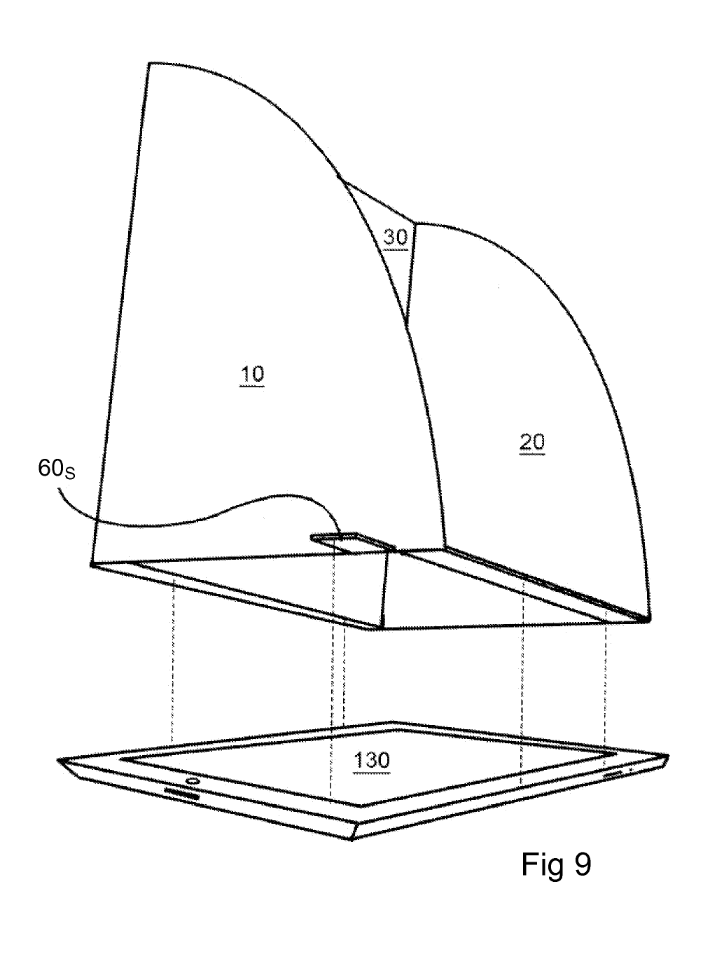

FIG. 9 illustrates a perspective view of the shielding apparatus in accordance with a second embodiment of the invention coupled with a tablet device in a landscape orientation. In this embodiment, the backside shade portion 30 is configured to be at a 90 degree angle from the display panel of the electronic apparatus 130. In this configuration of the backside shade portion 30, the shielding apparatus protects the display panel from glares from the sun or external light sources when the user is using the electronic device 130 to take photographs or video.

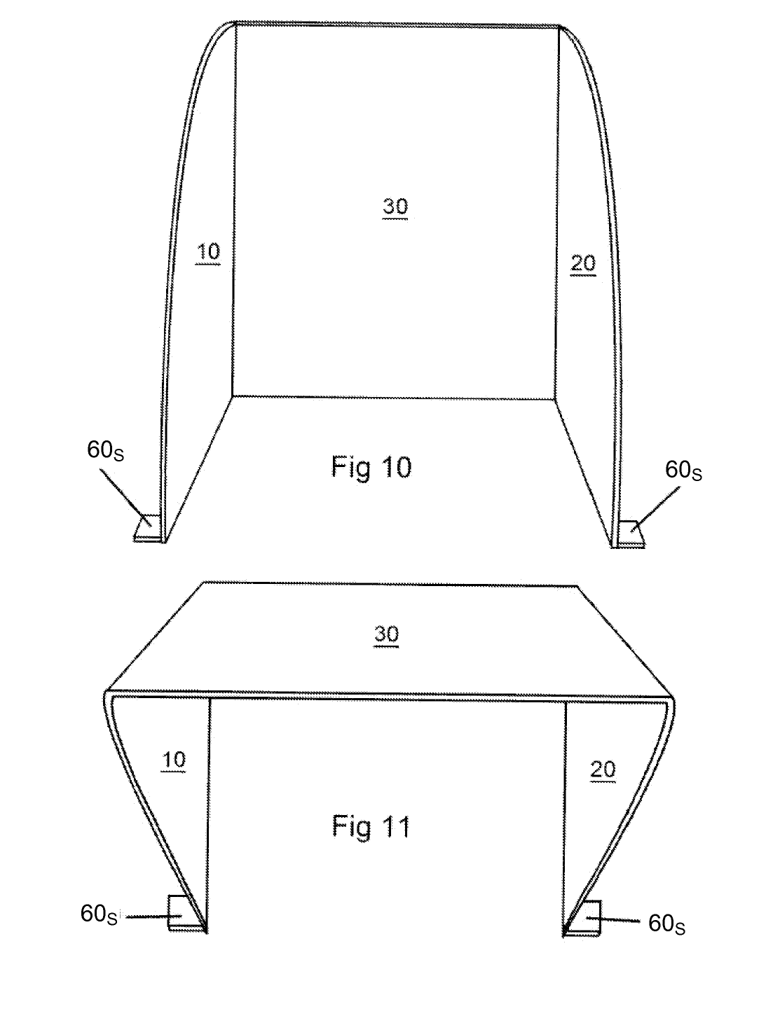

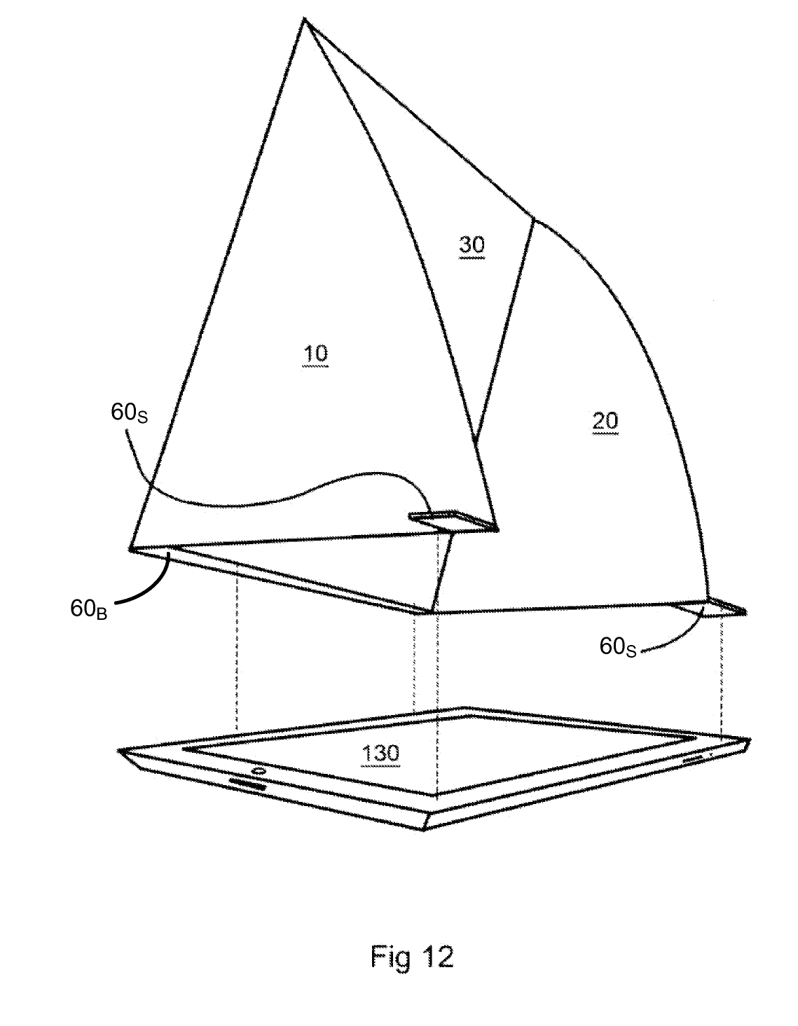

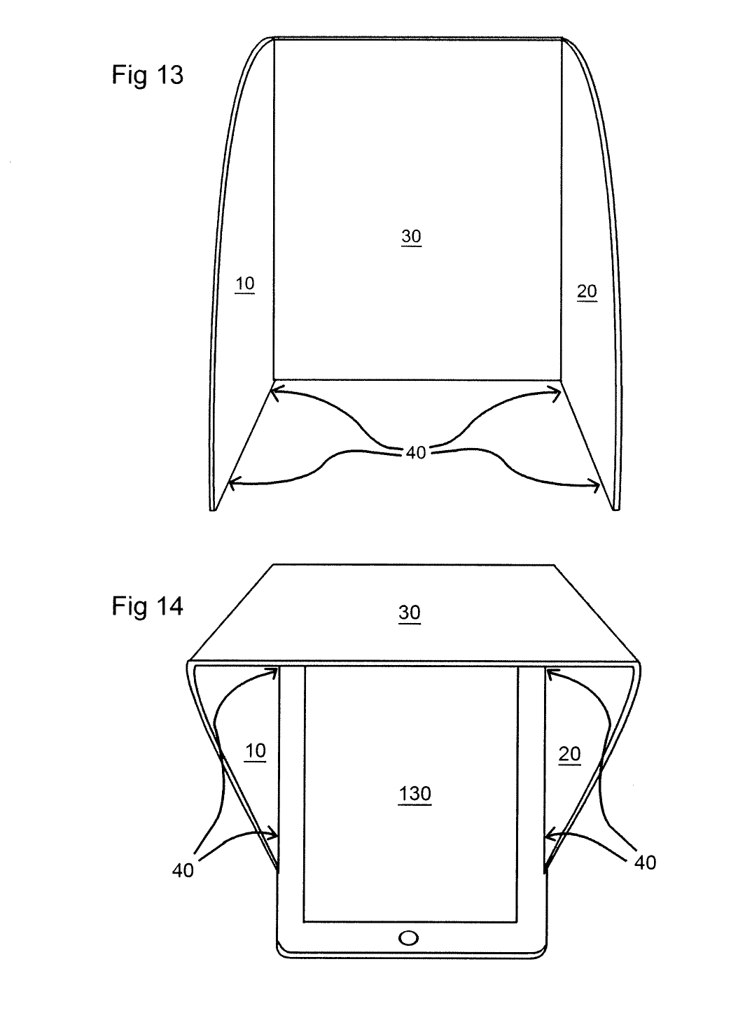

FIG. 10 illustrates a front view of the shielding apparatus in accordance with a third embodiment of the invention. FIG. 11 illustrates a top view of the shielding apparatus in accordance with a third embodiment of the invention. FIG. 12 illustrates a perspective view of the shielding apparatus in accordance with a third embodiment of the invention. FIG. 13 illustrates a front view of the shielding apparatus in accordance with the third embodiment of the invention. FIG. 14 illustrates a top view of the shielding apparatus in accordance with a third embodiment of the invention coupled with a tablet device in a portrait orientation.

This third embodiment is similar to the first embodiment, but in this embodiment, the holding portions in this shielding apparatus include the side holding portions 60_{S} that are coupled to each of the side shade portions 10, 20, and a bottom holding portion 60_{B} that is coupled to the bottom of the backside shade portion 30. In this embodiment, the side holding portions 60_{S} include one or more layers of fabric that are sewn into pouch that is attached to the bottom of the side shade portions 10, 20. In other embodiments, the side holding portions 60_{S} are included in the seams of the edge of the side shade portions 10, 20 as shown in FIGS. 13-14. While the FIGS. 10-12 illustrate the shielding apparatus being configured to be coupled to an electronic apparatus 130 in the landscape orientation, the shielding apparatus may also be configured to be coupled to an electronic apparatus 130 in the portrait orientation as illustrated in FIGS. 13-14.

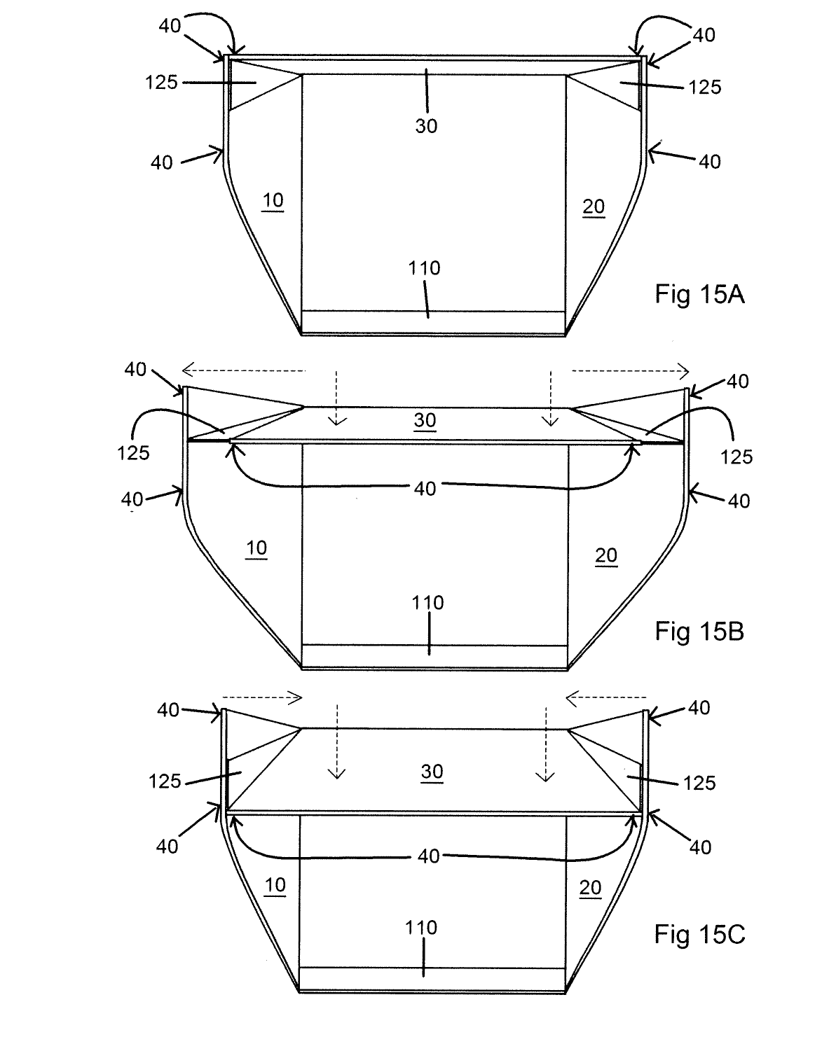

FIGS. 15A-15C illustrate a top view of the shielding apparatus in accordance with a fourth embodiment of the invention. In this embodiment, the shade portion of the shielding apparatus is configured such that the angle of the backside shade portion 30 from the display panel may be adjusted. The shade portion in this embodiment further includes an adjustment portion 125 that allows the backside shade portion 30 be moved from 90 degree angle from the display panel (FIG. 15A) to more acute angles (FIGS. 15B-15C). In FIG. 15C, the angle between the display panel and the backside shade portion 30 may be about 60 degrees. The corners of top portion of the backside shade portion 30 in this embodiment may include top holding portions that include magnets 40 therein. The top portion of the side shade portion 10, 20 may similarly include top holding portions that include magnets 40 therein. Accordingly, the positioning of the magnets 40 may be configured such that the backside shade portion 30 is adjustable to various angles as shown in FIGS. 15A-15C.

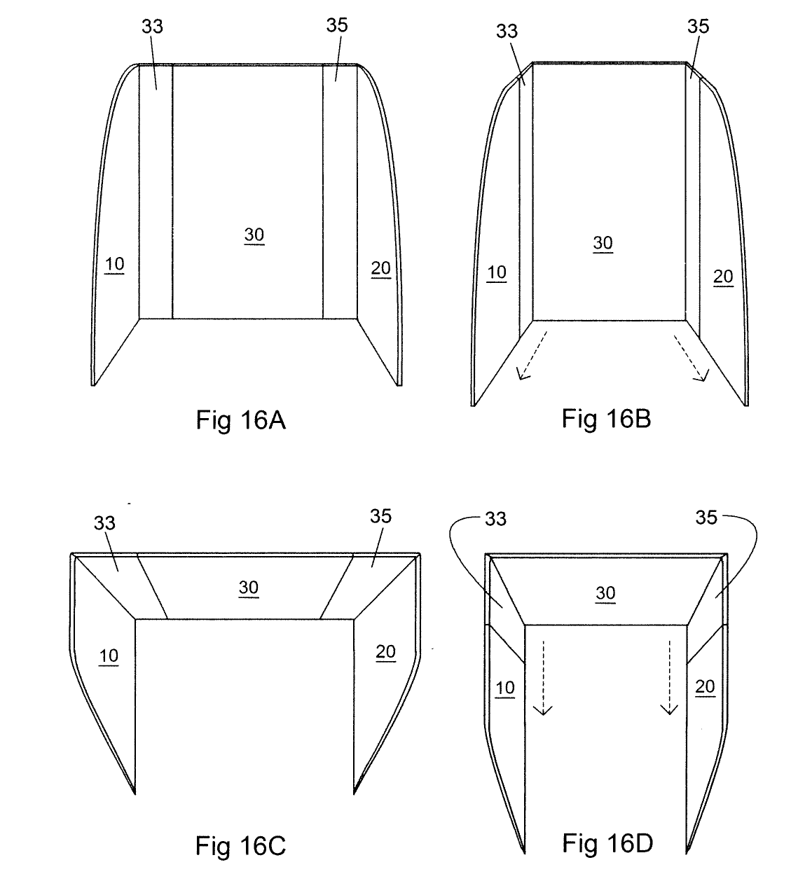

FIGS. 16A-16D illustrate front views of the shielding apparatus in accordance with a fifth embodiment of the invention (FIG. 16A-B), and top views of the shielding apparatus in accordance with the fifth embodiment of the invention (FIG. 16C-D). In this embodiment, the shade portion further includes a left panel 33 and a right panel 35 that allows the shielding apparatus to be coupled to an electronic device 130 that is oriented in a landscape orientation (FIGS. 16A, 16C) or in a portrait orientation (FIGS. 16B, 16D). In this embodiment, the shade portion may be folded at the edges of the left and right panels 33, 35 to adjust the shielding apparatus to the orientation of the electronic device 130. Accordingly, the width of backside shade portion 30 (e.g., includes the left and right panels 33, 35 in a landscape mode and does not include the left and right panels 33, 35 in portrait mode) is adjustable to allow the shade portion to surround a display panel in portrait orientation and in landscape orientation.

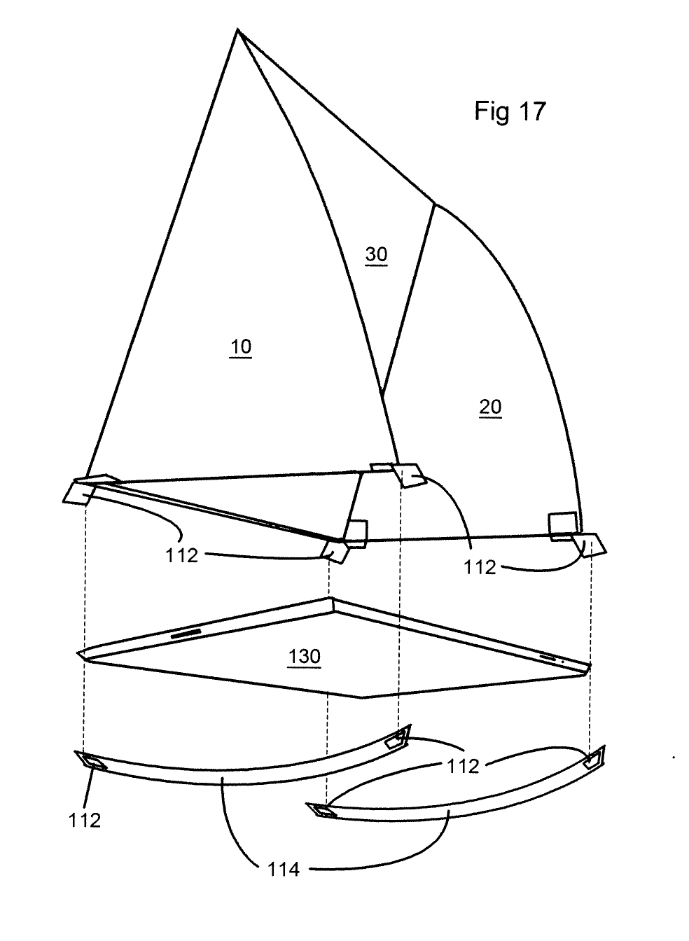

FIG. 17 illustrates a perspective view of the shielding apparatus in accordance with a sixth embodiment of the invention. In this embodiment, the bottom of the side shade portions 10, 20, are coupled to tab portions 112. The tab portions 112 may include Velcro segments. In this embodiment, the Velcro segments on the tab portions 112 on the shielding device may be coupled to the Velcro segments 112 on elastic structures 114. The elastic structures 114 may be elastic bands and hold the shielding structure in position on an electronic device 130. In another embodiment, the tab portions 112 are magnets or ferrous materials.

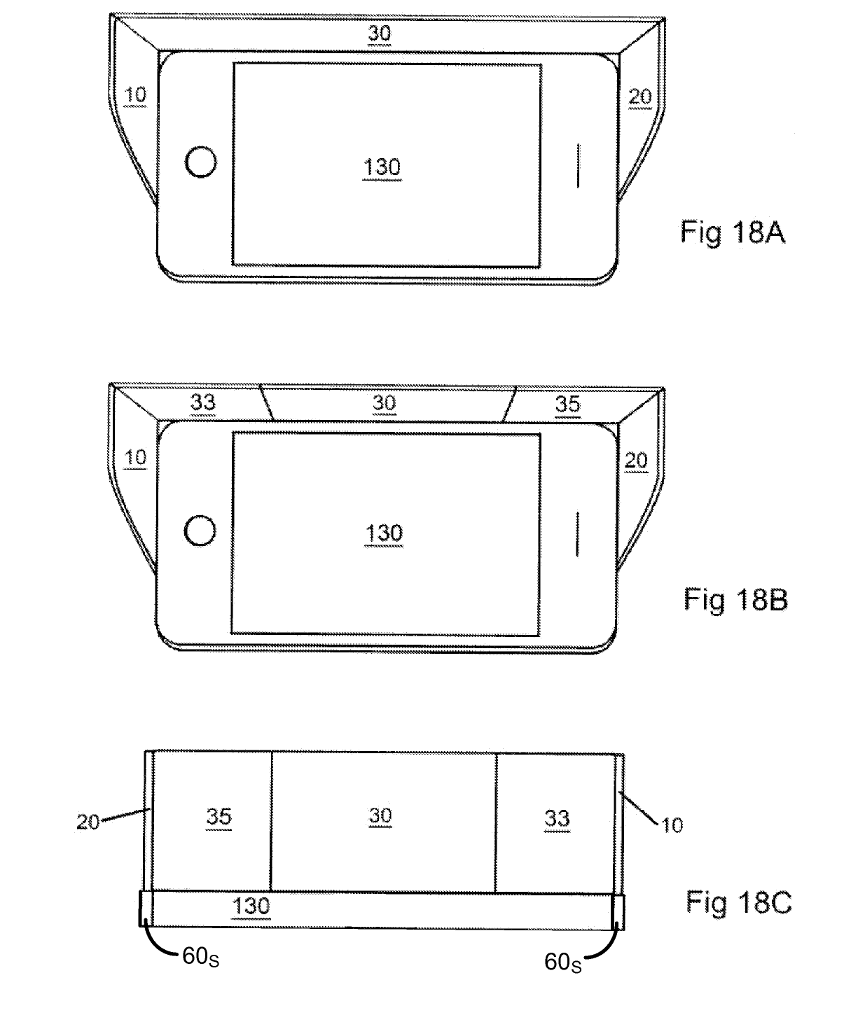

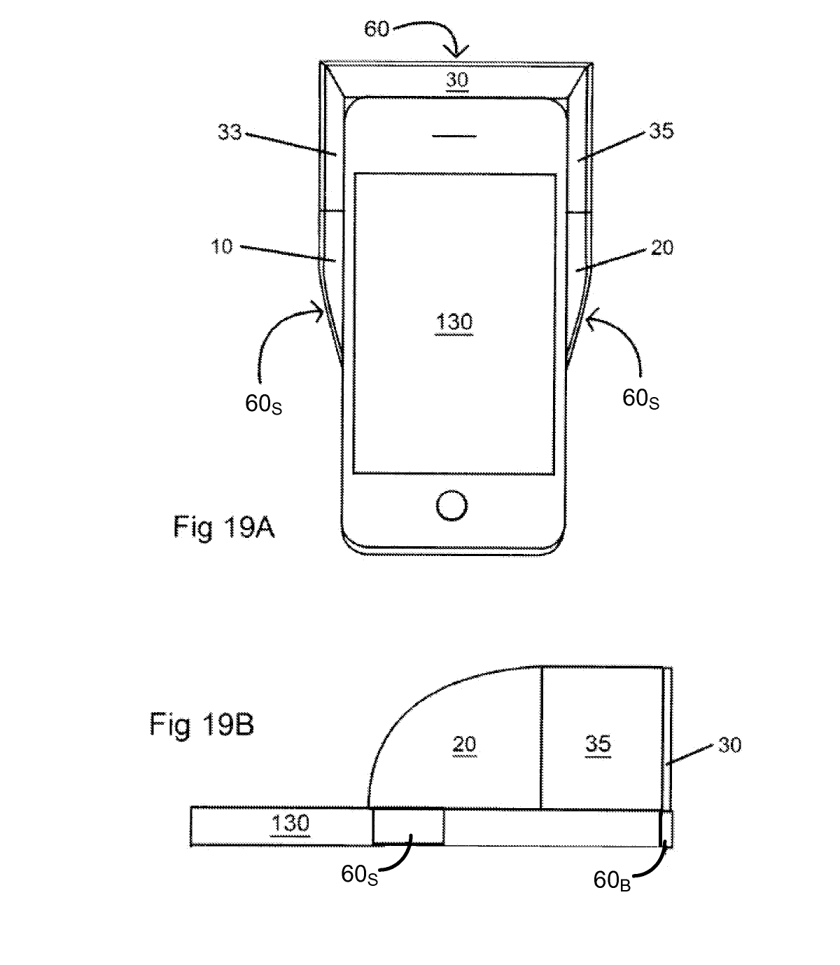

While the previous Figures illustrate the shielding apparatus being coupled to a tablet computer, it is understood that the shielding apparatus may be coupled to a variety of portable or non-portable electronic apparatuses. For instance, FIG. 18A illustrates a top view of the shielding apparatus according to a seventh embodiment of the invention coupled to a mobile telephone device (FIG. 18A). In this embodiment of the invention, the shade portion of the shielding apparatus is configured to be coupled to a mobile telephone device. This embodiment may be similar to the third embodiment in FIGS. 12-14 but sized to accommodate usage with a mobile telephone device 130. Further, FIGS. 18B-18C illustrate a top view of the shielding apparatus according to an eighth embodiment of the invention coupled to a mobile telephone device (FIG. 18B), and front view of the shielding apparatus according to the eighth embodiment of the invention coupled to a mobile telephone device (FIG. 18C). Moreover, FIGS. 19A-B illustrates a top view of the shielding apparatus according to the eighth embodiment of the invention (FIG. 19A) and a side view according to the eight embodiment of the invention coupled to a mobile telephone device (FIG. 19B). In this eighth embodiment, the shade portion of the shielding apparatus includes the left and right panels 33, 35 similar to the fifth embodiment illustrated in FIGS. 16A-16D. In this embodiment, the left and right panels 33, 35 allow for the width of backside shade portion 30 (e.g., includes the left and right panels 33, 35 in a landscape mode and does not include the left and right panels 33, 35 in portrait mode) to be adjusted such that the shade portion may be adjusted to surround a display panel in portrait orientation and in landscape orientation. As shown in FIGS. 18B-18C, the shielding apparatus is in a configuration to allow for coupling with a mobile telephone device 130 being used in the landscape orientation. As shown in FIGS. 19A-19B, when the shielding apparatus is in a configuration to allow for coupling with a mobile telephone device 130 being used in the portrait orientation, the left and the right panels 33, 35 are coupled to the sides of the mobile telephone device 130 such that the left and right panels 33, 35 effectively lengthen the side shade portions 10, 20.

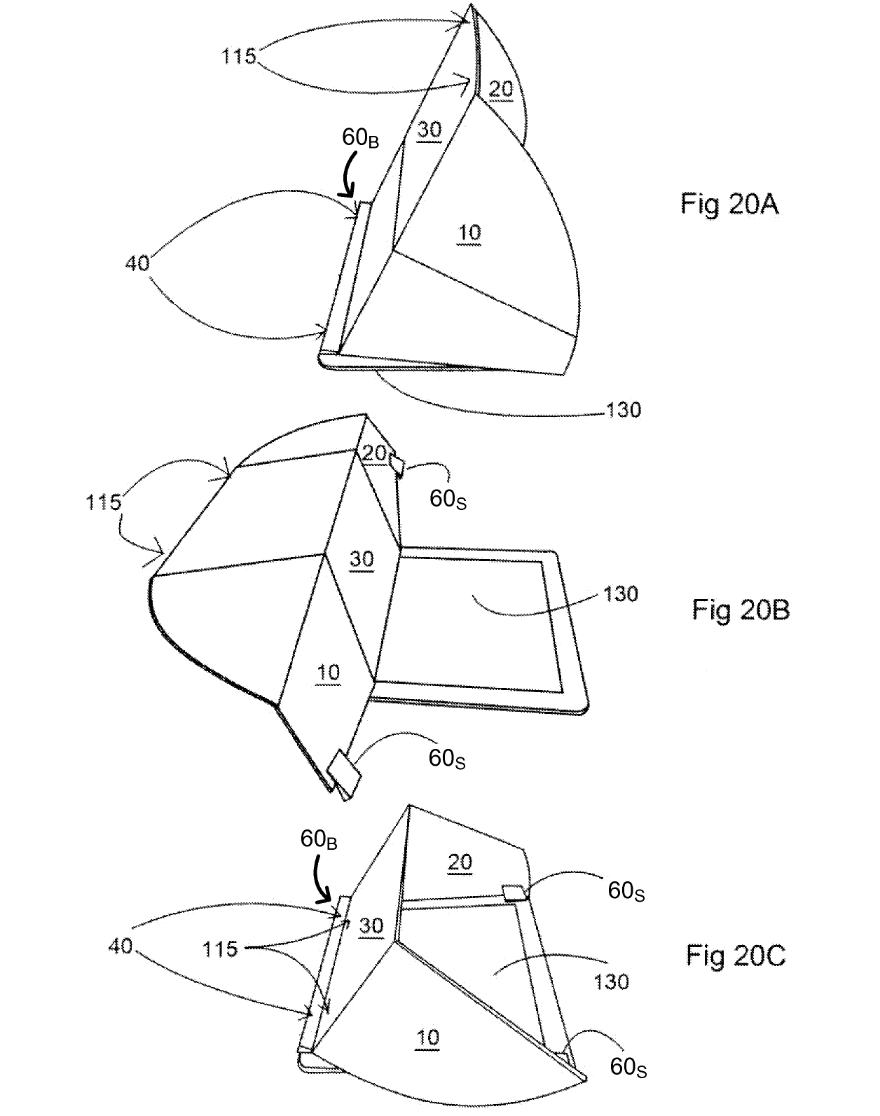

FIGS. 20A-20C illustrates a perspective view of the shielding apparatus according to a ninth embodiment of the invention in a light shielding mode (FIG. 20A), a perspective view of the shielding apparatus according to the ninth embodiment of the invention being converted from the light shielding mode to the privacy viewing mode (FIG. 20B) and a perspective view of the shielding apparatus according to the ninth embodiment of the invention in a privacy viewing mode (FIG. 20C). In this embodiment, the shielding apparatus includes a top holding portion coupled to the top side of the backside shade portion 30. The top holding portion 115 may include a structure with one or more portions of ferrous material. The top holding portion 115 may also include support structures made of materials such as foam, metal, elastic or plastic. In this embodiment, the height of the shade portion may be adjusted from a higher height (light shielding mode) as shown in FIG. 20A to a lower height (privacy mode) as shown in FIG. 20C by folding the shade portion along a seam as shown in FIG. 20B. The portions of ferrous material may be coupled to the magnets included in the bottom holding portion 60_{B} in order to maintain the shade portion at the lower height (privacy mode) as shown in FIG. 20C.

FIG. 21 illustrates a top view of the shielding apparatus according to a tenth embodiment of the invention. In this embodiment, the shade portion of the shielding apparatus includes solar material 170 that converts energy of light into electricity. The solar material 170 may be solar panels that convert the energy from sunlight into electricity. The solar material 170 may also be placed on the surface of the shade portion facing the display panel of the electronic device 130 such that the solar material 170 may also convert the energy from the light emitted by the display panel into electricity. In this embodiment, a battery unit 150 is coupled to the shade portion to store the electricity being generated by the solar material. In this embodiment, the battery unit 150 may provide power to the electronic device 130. The battery unit 150 may be coupled to the shade portion and the electronic device 130 via power charging chords 160.

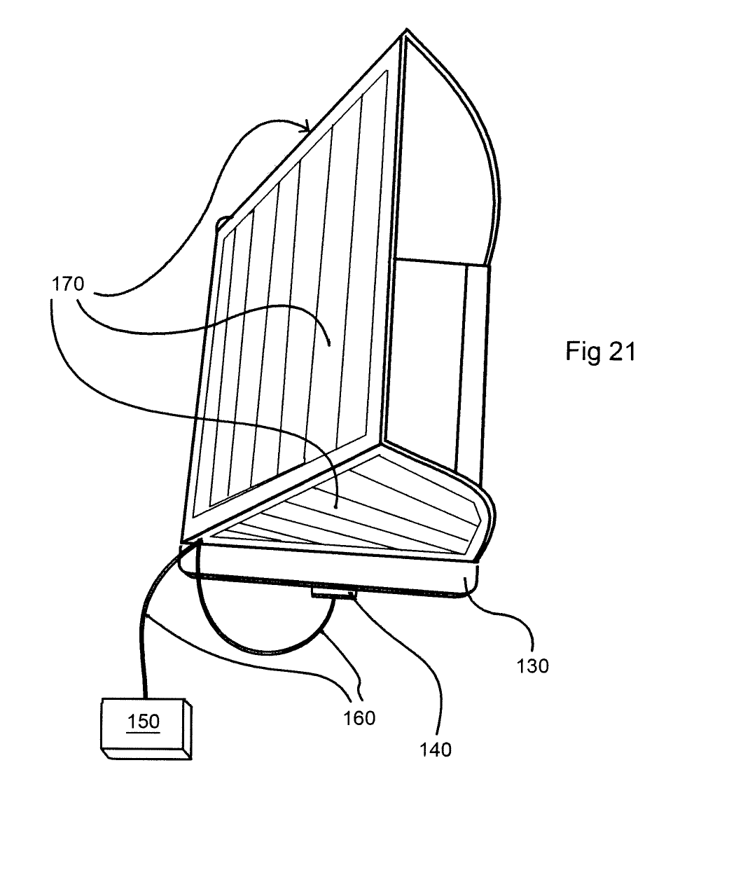

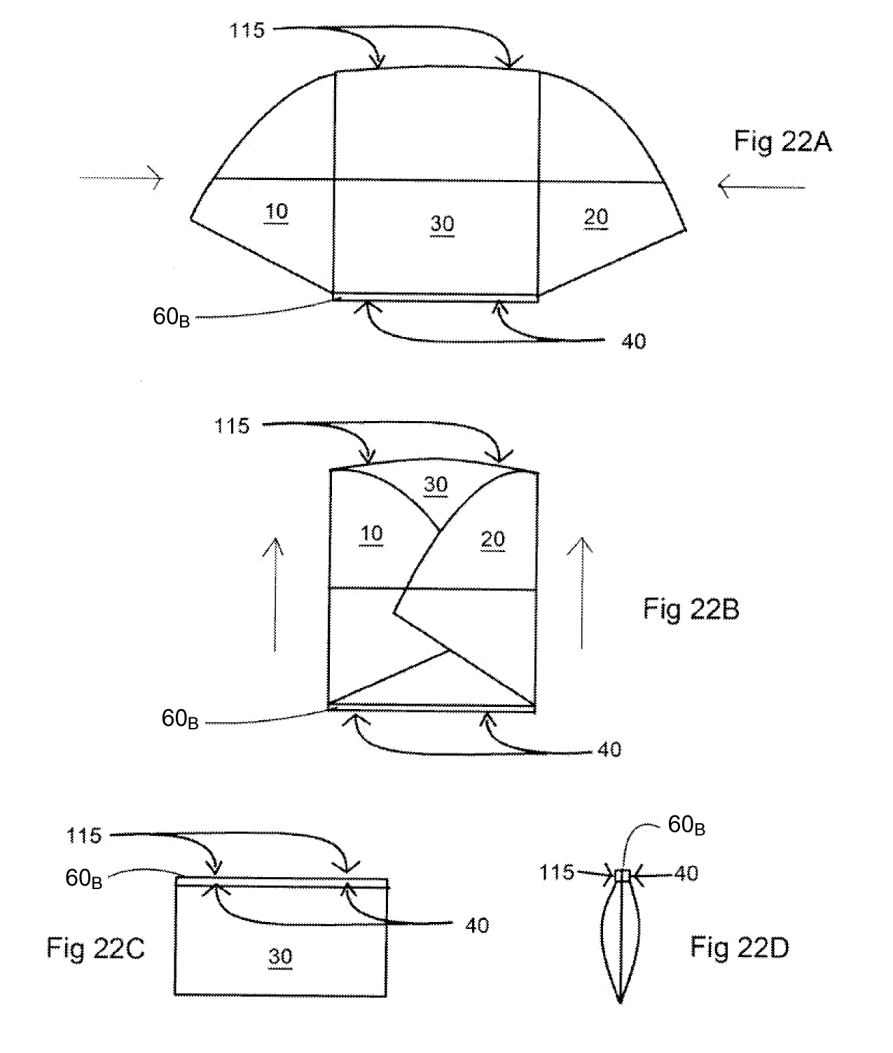

Referring back to the ninth embodiment from FIGS. 20A-20C, the ninth embodiment may be folded to a closed position for ease of storage and packing. FIGS. 22A-22D illustrates an open shielding apparatus according to the ninth embodiment of the invention (FIG. 22A) and views of a folded shielding apparatus according to the ninth embodiment of the invention (FIGS. 22B-D). As shown in the FIGS. 22A-22D, the ferrous material included in the top holding portion 115 couples with the magnets 40 included in the bottom holding portion 60_{B} when the shielding apparatus is in the closed position (FIGS. 22C-22D).

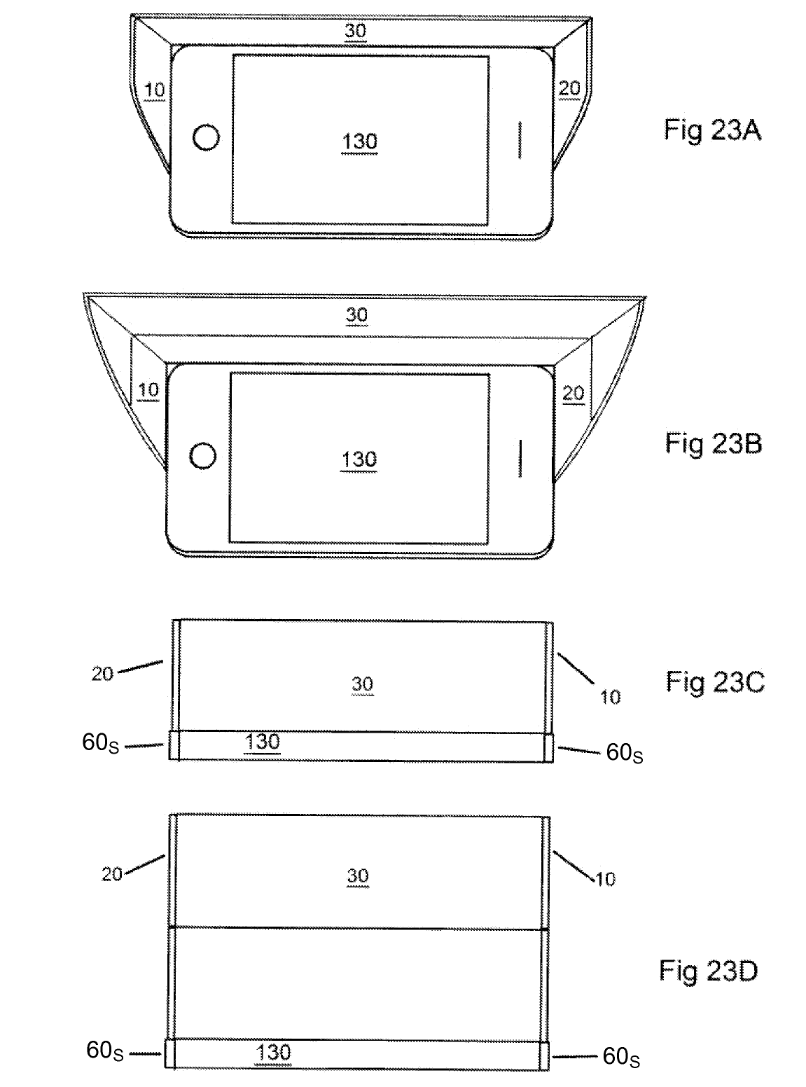

While the ninth embodiment as illustrated in FIGS. 20A-20C show the shielding apparatus being coupled to a tablet computer, it is understood that the shielding apparatus may be coupled to a variety of portable or non-portable electronic apparatuses. For instance, FIG. 23A-23D illustrate a top view of the shielding apparatus according to an eleventh embodiment of the invention coupled to a mobile telephone device (FIG. 23A-23B) and a front view according to the eleventh embodiment of the invention coupled to a mobile telephone device (FIG. 23C-23D). In contrast to the ninth embodiment, the shade portion of the shielding apparatus is configured to be coupled to a mobile telephone device. Similar to the ninth embodiment, the height of the shade portion of the shielding apparatus in this embodiment may be adjusted. FIGS. 23A and 23C illustrate the shielding apparatus with the shade portion at a higher height (light shielding mode) and FIGS. 23B and 23D illustrate the shielding apparatus with the shade portion at a lower height (privacy mode).

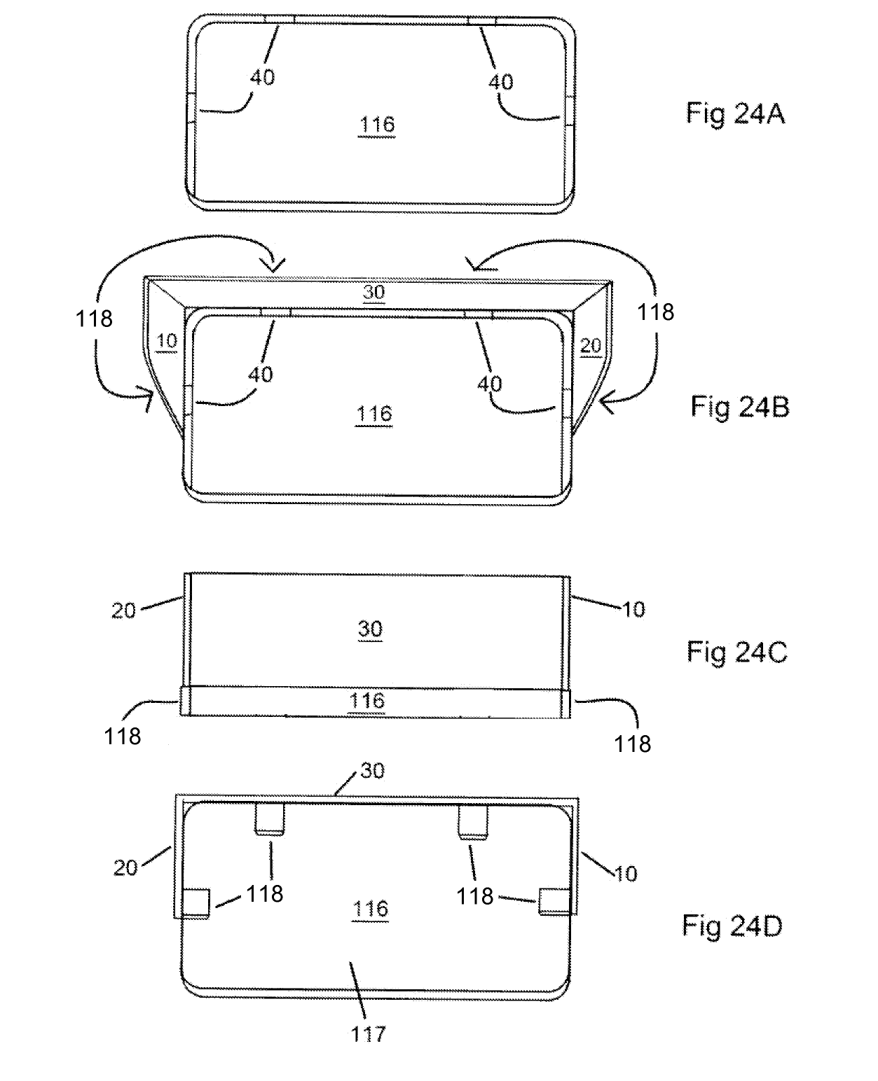

FIGS. 24A-24D illustrate a system for shielding a display panel of an electronic device 130. Specifically, FIG. 24A illustrates a top view of a housing according to the twelfth embodiment of the invention, FIG. 24B illustrates a top view of a shielding apparatus according the twelfth embodiment of the invention coupled the housing, FIG. 24C illustrates a front view of the twelfth embodiment of the invention coupled to the housing, and FIG. 24D illustrates a bottom view of the twelfth embodiment of the invention coupled to the housing. In this embodiment, the system includes a shielding apparatus that is coupled to a housing 116 that includes magnets portions 40. The housing may be a protective case for an electronic device 130. While the FIGS. 24A-24D illustrate the housing 116 for a mobile telephone device, it is understood that the housing 116 may be a protective case for a variety of electronic devices 130 as discussed above. In this embodiment, the shielding apparatus comprises the shade portion including a backside shade portion 30 and two side shade portions 10, 20. The shielding apparatus further includes holding portions 118 including bottom holding portions 118 coupled to a bottom side of the backside shade portion 30 and side holding portions 118 coupled to each of the side shade portions 10, 20. The holding portions 118 respectively include portions of ferrous material that couple to the plurality of magnet portions 40 in the housing 116, respectively. In one embodiment, the back of the housing 116 may include magnetic material 117 in the form of a panel or sheet to be coupled to the ferrous material in the holding portions 118.

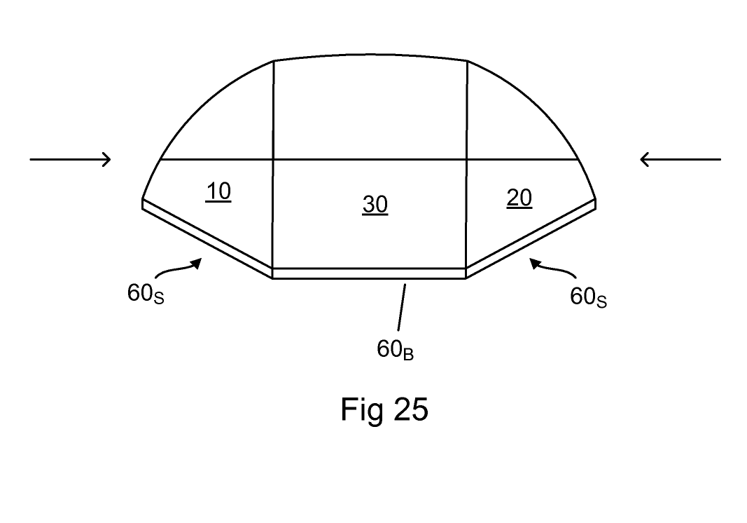

FIG. 25 illustrates an open shielding apparatus according to a thirteenth embodiment of the invention. In this embodiment, the holding portions 60_{B} and 60_{S} are made of one or more layers of fabric that are sewn into the shape of a pouch. In this embodiment, the bottom holding portion 60_{B} is a pouch that is the size of the length of the bottom side of the backside shade portion 30 while the side holding portions 60_{S} are pouches that are the size of the bottom side of the side shade portions 10, 20, respectively. In this embodiment, in lieu of including magnet portions 40, the holding portions 60_{B}, 60_{S} may include flexible material such as foam therein and may be coupled to a plurality of attachment layer portions, respectively. For instance, each of the attachment layer portions may include an adhesive, suction pads, or nano-suction pads (or micro-suction cups). In one embodiment, the attachment layer portions may be portions of suction cup tape that includes a plurality of nano-suction pads. The suction cup tape may include an adhesive side that is coupled to the bottom of each of the holding portions 60_{B}, 60_{S} and a nano-suction pads side that may be coupled to an electronic device 130. For instance, the nano-suction pads side may couple to the display panel of the electronic device 130 and/or to the housing of the electronic device 130. In this embodiment, the suction cup tape allows the apparatus from being attached to and removed from the electronic device 130.

In another embodiment, the bottom holding portion 60_{B} is coupled to at least one attachment layer portion while the side holding portions 60_{S} is not coupled to attachment layer portions. Alternatively, in another embodiment, the bottom holding portion 60_{B} that is a pouch the size of the length of the bottom side of the backside shade portion 30 is not coupled to an attachment layer portion whereas the side holding portions 60_{S} that are pouches the size of the bottom side of the side shade portions 10, 20, respectively, are coupled to attachment layer portions. In yet another embodiment, the side holding portions 60_{S} are pouches which are smaller than the size of the bottom side of the side shade portions 10, 20, respectively, as illustrated in FIG. 12, and the side holding portions 60_{S} may be coupled to the attachment layer portions, respectively. In this embodiment, the bottom holding portion 60_{B} may or may not be coupled to at least one attachment layer portion. While FIG. 25 illustrates the shielding apparatus that may be used with an electronic device 130 in the landscape orientation, it is understood that the shielding apparatus may be proportioned to be used with an electronic device 130 in the portrait orientation as previously described herein.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

What is claimed is:

1. An apparatus comprising:
a shade portion including a backside shade portion and two side shade portions, the shade portion to surround a display panel of an electronic device and limit a field of view to the display panel;
a plurality of holding portions including a bottom holding portion coupled to a bottom side of the backside shade portion and side holding portions coupled to each of the side shade portions; and
a plurality of attachment layer portions coupled to each of the side holding portions, respectively, wherein the attachment layer portions include suction cup tape to couple with the electronic device.

2. The apparatus of claim 1, wherein the shade portion includes a plurality of layers of fabric.

3. The apparatus of claim 2, wherein a flexible material is included between the plurality of layers of fabric to provide rigidity to the backside shade portion and the two side shade portions.

4. The apparatus of claim 3, wherein the flexible material is foam.

5. The apparatus of claim 3, wherein a plurality of support structures are included in between the plurality of layers of fabric to provide rigidity to the backside shade portion and the two side shade portions.

6. The apparatus of claim 5, wherein the plurality of support structures are made of spring steel.

7. The apparatus of claim 5, wherein the plurality of support structures are made of at least one of: plastic, elastic, and metal.

8. The apparatus of claim 2, wherein the shade portion is foldable between the backside shade portion and each of the two side shade portions.

9. The apparatus of claim 1, wherein a height of the shade portion is adjustable, wherein the height of the shade portion is adjusted by folding the shade portion.

10. The apparatus of claim 1, wherein a width of backside shade portion is adjustable to allow the shade portion to surround a display panel in portrait orientation and in landscape orientation.

11. The apparatus of claim 1, wherein the angle of the backside shade portion is adjustable.

12. The apparatus of claim 1, wherein the holding portions are made of one or more layers of fabric.

13. The apparatus of claim 1, wherein the suction cup tape includes an adhesive layer that is coupled to the side holding portions and a nano-suction pads side to couple to the electronic device.

14. The apparatus of claim 1, wherein the nano-suction pads side is removably coupled to the display panel or the housing of the electronic device.

15. The apparatus of claim 1, wherein one of the plurality of attachment layer portions is coupled to the bottom holding portion.

16. The apparatus of claim 1, wherein the bottom holding portion is a pouch being a size of the length of the bottom side of the backside shade portion and the side holding portions are pouches being a size of the bottom side of the side shade portions, respectively.

17. The apparatus of claim 1, wherein the bottom holding portion is a pouch being a size of the length of the bottom side of the backside shade portion and the side holding portions are pouches being a size that is smaller than the bottom side of the side shade portions, respectively.

18. An apparatus comprising:
a shade portion including a backside shade portion and two side shade portions, the shade portion to surround a display panel of an electronic device and limit a field of view to the display panel;
a plurality of holding portions including a bottom holding portion coupled to a bottom side of the backside shade portion and side holding portions coupled to each of the side shade portions; and
an attachment layer portion coupled to the bottom holding portion, wherein the attachment layer portion include suction cup tape to couple with the electronic device.
